(19) United States
(12) Patent Application Publication
(10) Pub. No.: US 2017/0282648 A1
(43) Pub. Date: Oct. 5, 2017

(54) SEMI-PNEUMATIC TIRE

(71) Applicant: Fredrick Taylor, Rome, GA (US)

(72) Inventor: Fredrick Taylor, Rome, GA (US)

(21) Appl. No.: 15/473,775

(22) Filed: Mar. 30, 2017

Related U.S. Application Data
(60) Provisional application No. 62/317,108, filed on Apr. 1, 2016.

(51) Int. Cl. B60C 3/04; B60C 7/12

(52) U.S. Cl. CPC B60C 3/04; B60C 7/125

(57) ABSTRACT

A semi-pneumatic tire including an annular outer portion having a surface engaging crown portion, a first shoulder portion and a second shoulder portion; an annular base portion spaced radially inward from the outer portion; and first and second sidewalls, laterally spaced, connecting the outer portion and base portion forming a closed chamber. The width of the crown portion is less than the width of the base portion.

### CROSS-REFERENCE TO RELATED APPLICATIONS

This application claims the benefit of and priority to U.S. Provisional Application Ser. No. 62/317,108, having the title “SEMI-PNEUMATIC TIRE,” filed on Apr. 1, 2016, the disclosure of which is incorporated herein in by reference in its entirety.

### TECHNICAL FIELD

The present disclosure generally relates to tubular tires that are not pressurized.

### BACKGROUND

Traditional pneumatic tires contain pressurized air which provides some cushioning in the ride, but can go flat if punctured, slashed, or otherwise compromised. Solid or foam filled tires are sometimes used for industrial applications over concerns that pneumatic tires may fail in the operational environment; however, solid tires do not provide the cushioned ride that may be desired. Accordingly, there is a need to address the aforementioned deficiencies and inadequacies.

### SUMMARY

The present disclosure provides a semi-pneumatic tire. A semi-pneumatic tire is hollow inside and not under pressure. A semi-pneumatic tire is typically light-weight, low-cost, puncture proof, and provides cushioning. These tires often come as a complete assembly with the wheel. They are used primarily for industrial or light commercial applications, such as lawn and garden. The semi-pneumatic tire is designed with an air chamber that is not pressurized to allow for a cushioned ride similar to a pneumatic tire, but will not go flat.

In an embodiment, a semi-pneumatic tire is provided having an unpressurized interior chamber. In an aspect, the tire, comprises: an annular outer portion having a surface engaging crown portion, a first shoulder portion and a second shoulder portion; an annular base portion spaced radially inward from the outer portion; and first and second sidewalls, laterally spaced, connecting the outer portion and the base portion forming a closed chamber; wherein the base portion has a rim portion that has a generally planar cross-section; and wherein the axial width of the crown portion is less than the axial width of the base portion.

In any one or more aspects, the planar cross-section of the closed chamber of the tire can be generally oval shaped. The base portion can comprise a rim surface portion, axially spaced annular rim seats, and axially spaced annular rim grooves. The shoulder portions can each have a large radius of curvature. The radius of curvature of the shoulder portions can range from about 36 degrees to about 44 with respect to a centerline across the cross-section of the tire parallel to the rim surface portion. At least a portion of the crown portion has a flat planar cross-section that can be substantially parallel to the planar cross-section of the rim portion; and wherein the axial width of the crown portion can be less than the axial width of the rim portion. The width of the crown portion across the cross-section of the tire (or axial width) can be 2 inches or less. The crown portion can have at least a portion of the exterior surface that is flat and that can be substantially parallel to the exterior surface of the base portion. The axial width of the base portion can be in the range from about 1 inch to about 5 inches. The axial width of the tire at the widest portion can be in the range from about 4 to about 8 inches. The height of the tire in cross section from a rim surface portion to a crown surface portion can be in the range of about 3.1 to about 5.1 inches.

Other systems, methods, features, and advantages of the present disclosure of a semi-pneumatic tire, will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings like reference numerals designate corresponding parts throughout the several views.

FIG. 1 depicts a cross-sectional view of a semi-pneumatic tire, according to various embodiments.

FIG. 2 depicts a front view of a semi-pneumatic tire, according to various embodiments.

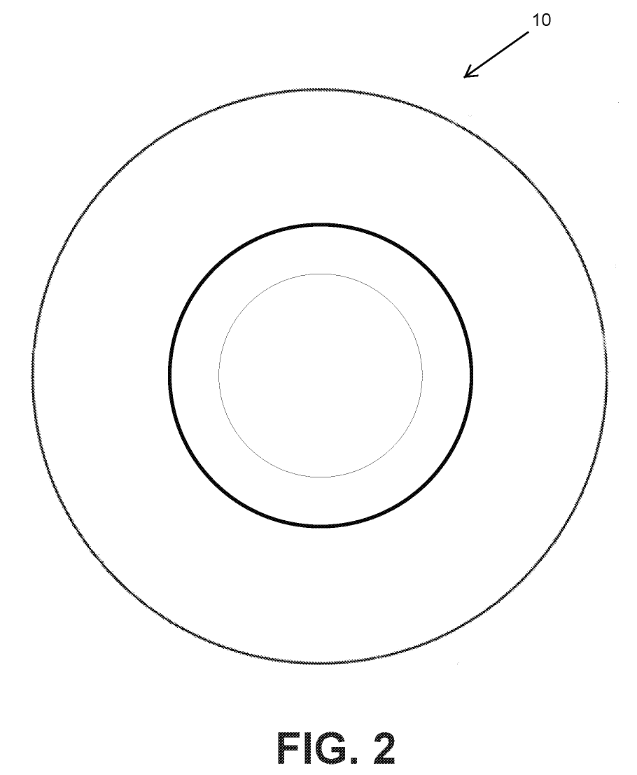

### DETAILED DESCRIPTION

Described below are various embodiments of the semi-pneumatic tire. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

The present disclosure is directed to a semi-pneumatic tire. Traditional pneumatic tires contain pressurized air which provides some cushioning in the ride, but can go flat if punctured, slashed, or otherwise compromised. Because of the operational environment, solid or foam filled tires are sometimes used for industrial applications over concerns that pneumatic tires may fail; however, solid tires do not provide the cushioned ride that may be desired. The semi-pneumatic tire of the present disclosure is designed with an interior chamber, which can contain non-pressurized air or other gas. This design allows for deflection over various surfaces and assists in suspension for the vehicle or equipment, without going flat if punctured. In various aspects, the present design offers a large radius in the shoulders of the tire and a flat interior center section or rim surface portion (in cross-section) that will work for all sizes of tires.

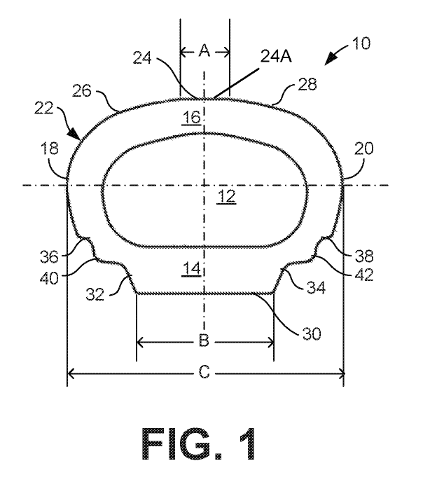

Various portions of the semi-pneumatic tire are described in relation to the axis of rotation of the tire. Shown in FIG. 1, the semi-pneumatic tire is generally planar in cross-section and generally symmetrical about a radial centerline.

The semi-pneumatic tire 10 has a generally toroidal shape with a hollow interior chamber 12 and varying wall thickness. The annular base portion 14 is configured to engage with a wheel rim. The annular outer portion 16 is configured to be in contact with a surface or the ground. The laterally spaced sidewall portions 18, 20 are generally curved and in contact with the base portion 14 and outer portion 16 to form an interior chamber 12. The planar cross-section of the interior chamber 12 is generally oval shaped. The interior chamber 12 can contain non-pressurized air or other gas. The planar cross-section of the exterior surface 22 is generally symmetrical about a radial centerline.

The semi-pneumatic tire 10 includes an annular outer portion 16, an annular base portion 14, and laterally spaced sidewall portions 18, 20 formed to create a closed interior chamber 12. The annular outer portion 16 has a surface engaging crown portion 24, a first shoulder portion 26, and a second shoulder portion 28. The shoulder portions 26, 28 are generally curved in cross-section. The annular base portion 14 is spaced radially inward from the annular outer portion 16. The annular base portion 14 has a rim surface portion 30, rim seats 32, 34, and rim grooves 36, 38. The rim surface portion 30 is generally flat, or planar, in cross-section and substantially parallel to the axis of rotation. The interior portion opposite the rim surface portion 30 is also generally flat or planar in configuration. The first rim seat 32 and second rim seat 34 are formed on each side of the rim surface portion 30 and are generally concave. The first rim groove 36 and second rim groove 38 are formed adjacent to each of the rim seats 32, 34, spaced radially and axially outward, and are generally concave. On each side of the tire, bead portions 40, 42 are convex portions between the rim seats 32, 34 and rim grooves 36, 38. The first and second sidewalls 18, 20 are generally curved.

In some aspects, the first and second rim seats 32, 34 can have a radius of curvature R1. In some aspects, the first and second rim grooves 36, 38 can have a radius of curvature R2. The convex bead portions 40, 42 also have a radius of curvature. For example, the radius of curvature of beads 40, 42 can be in the range of 92 degrees to 100 degrees, 93 degrees to 99 degrees, 94 degrees to 98 degrees, 95 degrees to 97 degrees, preferably 96 degrees. In some aspects, the shoulder portions of the first and second sidewalls 18, 20 can have a large radius of curvature of RS. For example, the radius of curvature of the shoulder portions can range from about 36 degrees to about 44 degrees, from about 37 degrees to about 43 degrees, from about 38 degrees to about 42 degrees, and from about 39 degrees to about 41 degrees, preferably about 40 degrees with respect to a centerline across the cross-section of the tire parallel to the rim surface portion 30.

In further aspects, the height of the tire in cross-section from the point between rim seats 32 and 36 on one side of the tire (and also from the point between rim seats 34 and 38 on the other side of the tire) to the outer surface of the crown portion 24 can be in the range of about 2.4 to about 4.4 inches, 2.9 to about 3.9 inches, 3.1 to about 3.7 inches, 3.2 to about 3.6 inches, 3.3 to about 3.5 inches, preferably about 3.4 inches. In some aspects, the height of the tire in cross section from a rim surface portion 30 to a crown surface portion 24 is in the range of about 2 to about 6 inches, about 2.5 to about 5.5 inches, about 3.1 to about 5.1 inches, preferably about 4.1 inches.

The base portion 14 can engage with wheel rim of varying diameter. The axial width A of the crown portion 24 can be a flat or planar section, generally parallel to a rim base of a wheel to which the tire is intended to be mounted. In various aspects the axial width A of the crown portion 24 can be 2 inches or less, for example in the range of ½ inch to about 2 inches, ½ inch to about 1 and ¾ inches, ½ inch to about 1 and ½ inches, ¾ inch to about 1 and ¼ inch, preferably about 1 inch. At least a portion, if not all, of the crown portion 24 can have a flat exterior surface portion 24A. For example, the flat exterior surface portion 24A of the crown portion 24 can be 20% of the exterior surface of the crown portion 24, 25%, 30%, 35%, 40%, 45%, 50%, 55%, 60%, 65%, 70%, 75%, 80%, 85%, 90%, 95% or more of the crown portion 24.

In various aspects, the axial width B of the rim surface portion 30 can be less than 8 inches, in the range of about 1 to about 5 inches, about 2 to about 4 inches, 2.4 to about 3.4 inches, preferably about 2.9 inches. In some aspects, the axial width A of the crown portion 24 can be less than the axial width B of the rim surface portion 30. The planar cross-section of the crown portion 24 can be substantially parallel to the planar cross-section of the rim surface portion 30 and also the inner surface of the rim portion opposite that of the outer rim surface portion 30. In various aspects, the axial width C of the tire at the widest portion can be less than 10 inches, for example in the range of about 4 to about 8 inches, about 4.5 to about 7.5 inches, about 5 to about 7 inches, preferably 5.8 inches.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

We claim:

1. A tire, comprising:
an annular outer portion having a surface engaging crown portion, a first shoulder portion and a second shoulder portion;
an annular base portion spaced radially inward from the outer portion; and
first and second sidewalls, laterally spaced, connecting the outer portion and the base portion forming a closed chamber;
wherein the base portion has a rim portion that has a generally planar cross-section; and
wherein the axial width of the crown portion is less than the axial width of the base portion.

2. The tire of claim 1, wherein the planar cross-section of the closed chamber is generally oval shaped.

3. The tire of claim 1, wherein the base portion comprises a rim surface portion, axially spaced annular rim seats, and axially spaced annular rim grooves.

4. The tire of claim 1, wherein the shoulder portions each have a large radius of curvature.

5. The tire of claim 4, wherein the radius of curvature of the shoulder portions range from about 36 degrees to about 44 with respect to a centerline across the cross-section of the tire parallel to the rim surface portion.

6. The tire of claim 2, wherein the shoulder portions each have a large radius of curvature.

7. The tire of claim 6, wherein the radius of curvature of the shoulder portions range from about 36 degrees to about 44 with respect to a centerline across the cross-section of the tire parallel to the rim surface portion.

8. The tire of claim 1, wherein at least a portion of the crown portion has a flat planar cross-section that is substantially parallel to the planar cross-section of the rim portion; and
wherein the axial width of the crown portion is less than the axial width of the rim portion.

9. The tire of claim 5, wherein at least a portion of the crown portion has a flat planar cross-section that is substantially parallel to the planar cross-section of the rim portion; and
wherein the axial width of the crown portion is less than the axial width of the rim portion.

10. The tire of claim 7, wherein at least a portion of the crown portion has a flat planar cross-section that is substantially parallel to the planar cross-section of the rim portion; and
wherein the axial width of the crown portion is less than the axial width of the rim portion.

11. The tire of claim 1, wherein the axial width of the crown portion is 2 inches or less.

12. The tire of claim 1, wherein the axial width of the base portion is in the range from about 1 inch to about 5 inches.

13. The tire of claim 1, wherein the axial width of the tire at the widest portion is in the range from about 4 to about 8 inches.

14. The tire of claim 1, wherein the height of the tire in cross section from a rim surface portion to a crown surface portion is in the range of about 3.1 to about 5.1 inches.

15. The tire of claim 11, wherein at least 20% of the exterior surface of the crown portion in cross-section is flat.

16. The tire of claim 8, wherein at least 20% of the exterior surface of the crown portion in cross-section is flat.
